(19) United States
(12) Patent Application Publication
(10) Pub. No.: US 2018/0193923 A1
(43) Pub. Date: Jul. 12, 2018

(54) Additive Manufacturing Method

(71) Applicant: Ford Global Technologies, LLC, Dearborn, MI (US)

(72) Inventors: Raphael KOCH, Odenthal (DE); Clemens VERPOORT, Monheim am Rhein (NL); Bruno ALVES, Huerth (DE)

(73) Assignee: Ford Global Technologies, LLC, Dearborn, MI (US)

(21) Appl. No.: 15/866,386

(22) Filed: Jan. 9, 2018

(30) Foreign Application Priority Data
Jan. 9, 2017 (DE) 102017200152.6

(51) Int. Cl. B22F 7/04; B22F 3/105; B33Y 10/00; B23K 26/34; B23K 26/354

(52) U.S. Cl. CPC B22F 7/04; B22F 3/1055; B22F 2003/1042; B23K 26/34; B23K 26/354; B33Y 10/00

(57) ABSTRACT

The present disclosure relates to an additive manufacturing method. The method includes applying metallic powder in layers to a base surface. The base surface is formed in part by a base plate and in part by at least one insert arranged in a through opening in the base plate. The metallic powder layers are bonded in some region or regions by heating, whereby an object having connecting structures that are connected to the at least one insert is manufactured. After manufacture is finished, each insert is adjusted within a through opening relative to the base plate, thereby separating at least parts of the connecting structures from the insert.

### CROSS-REFERENCE TO RELATED APPLICATIONS

This application claims priority to and the benefit of German Application No. 102017200152.6 filed on Jan. 9, 2017. The disclosure of the above application is incorporated herein by reference.

### FIELD

The present disclosure relates to an additive manufacturing method.

### BACKGROUND

The statements in this section merely provide background information related to the present disclosure and may not constitute prior art.

Nowadays there are various methods by means of which three-dimensional models can be produced on the basis of design data from materials that are amorphous or neutral in terms of shape, such as powders (if appropriate with the addition of a binder) or liquids (which sometimes also includes melted solids). These methods are also known by collective terms such as “rapid prototyping”, “rapid manufacturing” or “rapid tooling”. Often this involves a primary forming step, in which the starting material is either in liquid form from the outset or is liquefied temporarily and hardens at an intended location. One known method in this context is “fused deposition modeling” (FDM), in which a workpiece is built up in layers from a thermoplastic material. The plastic is fed in, in the form of powder or of a strand, for example, melted and applied in melted form by a printing head, which successively applies individual, generally horizontal, layers of the object to be produced.

In addition, methods in which a powdered substance, e.g. a plastic, is applied in layers and cured selectively by means of a binder that is applied or pressed on locally are known. In yet other methods, e.g. selective laser sintering (SMS), a powder is applied in layers to a base plate, e.g. with the aid of a doctor. The powder is selectively heated by means of a suitable focused beam, e.g. a laser beam, and is thereby sintered. After a layer has been built up, the base plate is lowered slightly and a new layer is applied. Plastics, ceramics or metals can be used as powders in this context. After the production process, the unsintered powder must be removed. In a similar method, selective laser melting (SLM), the amount of energy input by means of the radiation is so high that the powder is partially melted and solidifies to form a coherent solid body.

In many cases, it is necessary, in addition to the actual usable shape of the object, additionally to produce supporting structures or connecting structures which connect the object to the base plate. These can be columns, webs, stilts or similar elements, which normally extend vertically. On the one hand, they serve to ensure reliable support in the case of overhanging shapes and to prevent parts of the object being displaced during the manufacturing process. On the other hand, particularly in the case of manufacturing methods such as SLM, which are associated with high heat input, the connecting structures ensure heat dissipation from the object to the base plate and prevent the object from being distorted by temperature differences during manufacture.

Once the manufacture of the object is complete, it must be removed from the base plate together with the connecting structures, for which purpose the base plate must generally be removed from the manufacturing apparatus. All this is performed manually, thereby significantly increasing cycle times and production costs. Nowadays, manual separation of the object from the base plate is normally accomplished by spark erosion (EDM, electrical discharge machining), to be more precise wire erosion, or mechanically, e.g. by means of a saw. Apart from the time expended, there is the issue, with wire erosion, that the wire tends to crack on contact with metal powder. This means a further delay and increase in costs. Owing to the issues indicated, methods such as SLS or SLM are currently not suitable for economical series production.

U.S. Pat. No. 5,753,274 A discloses an additive manufacturing method in which an object is produced by layered selective sintering or melting of a powdered material. In this process, a pre-produced plate of a material to which the first layer of the object adheres is used as a basis for manufacture. Said plate is secured on a supporting platform of the manufacturing apparatus by screw fastening, for example.

CN 204020013 U discloses a positioning method for a printing head of a 3-D printer. In the case of the printer shown, an object is built up on a plastic plate, which is secured on a base platform by means of clamping. After the end of manufacture, the plastic plate can be removed from the base platform together with the object.

JP H02-128829 A shows an additive manufacturing method in which an object is produced by layered hardening of a light-hardenable liquid. Here, buildup is performed on a flexible base plate. During manufacture, the base plate is supported in a level manner. On completion of manufacture, the base plate is bent, thereby detaching it from the manufactured object.

U.S. Patent Application No. 2014/0178588 A1 shows a 3-D printing method in which FDM is used to print an object onto a base, which can be formed either by an endless film or by a plate. Here, the plate has a plurality of recesses into which the hardened material of the object fits and thus produces anchoring on the plate by means of positive engagement.

CN 104772463 A discloses an additive manufacturing method for metallic objects in which special supporting structures are produced on the object, consisting of hollow or prismatic columns. The cross section of the columns can be square or hexagonal, for example, and recesses can be provided in the wall of the column.

WO 2015/107066 A1 discloses an additive manufacturing system in which a radiation-hardenable liquid, which is applied to a transparent film, is selectively hardened in layers. Here, the hardening radiation is partially screened off by an interposed mask. The object is built up from the top down, wherein, after the hardening of each layer, the object is detached from the film and moved upward by one layer thickness. For detachment, the film, which is level during the hardening of the layer, is bent convexly.

U.S. Patent Application No. 2014/0335313 A1 discloses an additive manufacturing method for producing an object from metallic powder. Supporting structures are produced in order, on the one hand, to secure overhanging parts of the object and, on the other hand, to ensure heat dissipation. Here, the supporting structures are not in direct contact with the rest of the object but are separated from it by a thin, powder-filled gap, the width of which is chosen in such a way that effective heat transfer through the gap is possible.

EP 0 857 111 B1 discloses a film laminate having a substrate film and protective films, which are laminated onto the substrate film on both sides with an adhesive layer in between. Here, the adhesive layer is a pressure-sensitive adhesive layer hardened by radiation. On an opposite side of the protective film, a further layer hardened by means of an electron beam, for example, is laminated on, this being intended to prevent unwanted adhesion of the film laminate.

In view of the indicated prior art, the efficiency of additive manufacturing methods still leaves room for improvement. In particular, it is desirable to provide a powder-based method which operates more quickly and can be automated, making it suitable also for series manufacture.

### SUMMARY

The present disclosure provides an efficient additive manufacturing method.

According to the present disclosure, an additive manufacturing method is provided having the features of claim 1, wherein the dependent claims relate to advantageous forms of the present disclosure.

It should be noted that the features and measures presented individually in the following description can be combined in any technically feasible manner and give rise to further forms of the present disclosure. The description additionally characterizes and specifies the present disclosure, especially in conjunction with the figures.

The present disclosure provides an additive manufacturing method. The method can be assigned to the rapid prototyping sector. However, as will become clear below, it is suitable not only for manufacturing prototypes or individual models but especially also for series manufacture.

In the method according to the present disclosure, metallic powder is applied in layers to a base surface, which is formed in part by a base plate and in part by at least one insert arranged in a through opening in the base plate, and is bonded in some region or regions by heating, whereby an object having at least one connecting structure that is connected to the insert is manufactured. Here, any material in powder or particle form which comprises at least one metal is referred to as a metallic powder. This can also be an alloy or a mixture of particles of different metals. The powder can also contain semi-metals or nonmetals, e.g. as a component of an alloy. Aluminum, titanium and iron are among the suitable metals.

The powder is applied in layers, normally along a buildup surface, which, in particular, can extend parallel to the base surface. That is to say that a layer of this powder is in each case applied, e.g. by means of an application device. Here, the layer thickness can be between 10 μm and 500 μm, for example, although other layer thicknesses are also conceivable. Such an application device can have one or more discharge openings, from which the powder emerges, following the force of gravity for example. In order to allow a smooth and uniform layer buildup, the application device can comprise a smoothing device, e.g. a doctor or blade, which is moved parallel to the base surface and smooths the surface of the powder. Normally, the buildup surface is level. During this process, application takes place in layers onto the base surface, i.e. the first layer is applied directly to the base surface, after which further layers are applied successively one on top of the other. In one form, the base surface is at least a predominantly level design, wherein relatively small local deviations from the level shape may be unproblematic.

The base surface normally extends horizontally, wherein horizontal powder layers are layered one on top of the other (in a vertical direction). In some circumstances, however, the base area can deviate at least partially from the horizontal and enclose with the latter an angle of up to 30°, for example. Care should be taken to provide an angle that is less than the angle of repose of the respective metallic powder in order to inhibit it from slipping off.

Here, the base surface to which the powder is applied is formed in part by a base plate and in part by at least one insert arranged in a through opening in the base plate. Here, the term “plate” should not be interpreted restrictively in respect of the shape, to the effect that the base plate must necessarily have a uniform thickness. In particular, the base plate can also be firmly connected to a component which cannot be described as plate-shaped. Normally, the base plate has a smaller dimension perpendicularly to the base surface than in the direction of the base surface, although this is not necessarily the case. In a wider sense, it could also be referred to a “base body” instead of a base plate. The base plate (to be more precise: a surface of the base plate) forms a part (or a partial surface) of the base surface. Another part (or another partial surface) is formed by the at least one insert (to be more precise: by a surface thereof). The base plate has at least one through opening, wherein an insert is arranged in each through opening. In principle, this includes the possibility that more than one insert is arranged in a through opening, but normally there is just one insert per through opening. Since this is a through opening, the respective insert can also be reached from a side of the working plate facing away from the base surface and can optionally also be inserted and removed from this side. The base surface is formed in part by the base plate and in part by the insert or inserts, i.e. the powder is applied both to the base plate and to the inserts, to be more precise to those surfaces which form the base surface.

In order to enable the individual layers to be built up one on top of the other, the base plate can be moved together with the inserts by one layer thickness in each case after the application of a layer. In this way, the application of a layer can consistently take place at the same level relative to a stationary system. As an alternative, it would also be conceivable, if generally more expensive, for the base plate to be held stationary and for an application device to be moved progressively higher.

The powder applied in layers is bonded in some region or regions by heating. That is to say that regions of each layer are heated, causing the powder particles to join together. At the same time, a bond is also established to the layer underneath. During the heating process, the melting temperature of the metallic powder can be exceeded, resulting in actual melting, or the melting temperature is not reached, wherein bonding takes place by sintering. It is also possible to conceive of procedures in which the powder particles are bonded partially by melting and partially by sintering. Normally, heating is performed by the action of radiation (e.g. electromagnetic radiation or an electron beam), by means of which the powder is either melted and solidifies or is sintered. In particular, the bonding of the powder can be accomplished by selective laser melting (SLM), selective electron beam melting (SEBM) or selective laser sintering (SLS).

Of course, the heating or action of radiation normally takes place in accordance with a certain pattern here to give a targeted manufacturing process. It would also be possible to say that a predetermined area is heated or irradiated. During this process, it is possible for the area to be scanned by a narrowly focused beam, for example, or, alternatively, for a certain beam pattern to be projected all at once. Here, the alignment of a laser beam, for example, relative to the base surface is generally not accomplished by moving a laser itself but by deflecting a beam produced by the laser by means of at least one movable mirror. It is self-evident that the spatial or time-based beam pattern can be controlled in accordance with predetermined data (e.g. CAM data) of an object to be produced. Here, the irradiated area corresponds to a cross section of the object, said cross section generally being flat.

Through the layered application and selective bonding of the powder, an object having at least one connecting structure that is connected to the at least one insert is manufactured. That is to say that the object is built up layer by layer, wherein one or more connecting structures are produced which connect the object to the at least one insert. Here, the connecting structures are not normally part of the usable form of the object but represent auxiliary structures which, on the one hand, can serve for mechanical support (and can therefore also be referred to as supporting structures) and, on the other hand, serve for heat dissipation to the insert. In respect of the heat input associated with building up the object, there would otherwise be a risk of large local temperature differences, which would remain over a relatively long period of time. Good heat dissipation from the object is not possible either to surrounding gases or through powder adjoining the object since both are relatively poor heat conductors. The connecting structures allow improved heat dissipation to the at least one insert. Thermally induced deformation, e.g. bending or distortion of the object, is thereby also at least largely avoided. Without the presence of the base body, the object could be deformed to such an extent that the application of a subsequent powder layer would be hindered, for example. Connecting structures of this kind can take the form of holders, suspension devices, supports, stilts or the like. They can also have a pierced, e.g. grid-, network- or honeycomb-type structure. The plural “connecting structures” should not be interpreted as restrictive in respect of the physical form and also includes a single form which is substantially physically coherent. The connection to the at least one insert can be based on the fact that the at least one connecting structure is fused or at least sintered locally with said insert, for example, or, alternatively, that only the metallic powder melts and, after solidification, adheres to the insert, which has not melted.

It is desirable if both the base plate and the inserts are composed at least predominantly of a material of high thermal conductivity, e.g. a metal. Effective heat dissipation via the connecting structure(s) of the object to the inserts and from the inserts to the base plate is thereby made possible. The respective insert is in heat-conducting contact with the base plate, according to one form. However, it is also conceivable for heat dissipation from the inserts to take place at least to some extent not via the base plate but via another component.

After manufacture is finished, each insert is adjusted within a through opening relative to the base plate, thereby separating at least parts of the at least one connecting structure from the insert. The adjustment of the respective insert can be any type of change in position relative to the base plate, i.e. it would also be possible to say that the position of the insert relative to the base plate is changed. The adjustment can comprise a rotation and/or a (linear) displacement of the insert relative to the base plate. By means of the adjustment, the respective connecting structure is separated completely or partially from the insert. It is possible for parts of the connecting structures to remain on the insert. Ultimately, separation is based on the fact that the object cannot follow the movement of the insert during the adjustment. There can be various reasons for this. In the case of just one insert, it is possible for the adjustment to take place quickly, as it were in the manner of a jerk, with the result that the object cannot follow the movement quickly enough owing to its inertia, as a result of which the connecting structure is separated. It is also possible for the object to be in contact with the base plate or to come into contact therewith through the adjustment, thereby inhibiting it from following the movement of the insert. Furthermore, the object can be gripped by a holding device (a gripper or the like) for the process of adjustment. It is also possible for the object to be connected to a plurality of inserts, wherein separation results from the fact that the various inserts are not adjusted in parallel and/or are adjusted at different times. It is furthermore conceivable for the unbonded powder not to be removed initially and for the object to remain embedded therein, while the insert or inserts are adjusted. In this case, the powder bed, which, for its part, is supported on a side wall or the like, can secure the object against displacement. The separation of a connecting structure can be based on a bending stress, shear stress and/or tensile stress, for example. Separation can be based on cracking or breaking off.

Before the adjustment of the at least one insert, the base plate together with the insert(s) and the object, including the connecting structure(s), is usually removed from a manufacturing region within an additive manufacturing apparatus. In this case, the separation of the connecting structures takes place at some other location. However, it is also possible to conceive of forms in which the base plate remains in the manufacturing apparatus while the separation of the connecting structures is carried out.

By virtue of the method according to the present disclosure, it is possible to dispense with the use of additional mechanical cutting or separating tools or other cutting or separating tools. The separation of the connecting structures is accomplished by the adjustment of the at least one insert. Since each insert is arranged in a through opening, adjustment can be performed from a side facing away from the finished object and from the base surface, i.e. there is no need to reach into the region above the base surface. There is also no need directly to touch the surface of the inserts on which the connecting structure is situated. That is to say that, even in cases in which this region is difficult to access owing to the shape of the object, separation can be carried out in a simple and reliable manner. The method is therefore also suitable for low-cost series production of workpieces. Since separation is possible from a side of the base plate facing away from the object, there is also reduced risk of unwanted damage to the object during this process.

In many cases, parts of the connecting structure remain even after the adjustment to the respective insert, and therefore the insert cannot be used for another manufacturing operation without being cleaned or reconditioned. According to one variant, therefore, at least one insert is removed from the through opening after the separation of the at least one connecting structure. It can be cleaned or reconditioned in some other way, if appropriate, so that it can be reused. If such reconditioning is not envisaged or is very time-consuming, it is possible, according to one form, for a new insert to be arranged in the through opening after the removal of the insert from the through opening. The manufacture of the next object can then be carried out in a corresponding manner with this new insert.

The base plate, in one form, has a plurality of through openings, in each of which an insert can be arranged. In this case, the connecting structures produced are connected to a plurality of inserts. This is advantageous inasmuch as the object can be secured in different, mutually spaced regions, wherein reliable separation of the respective connecting structures is nevertheless possible through mutually independent adjustment of the inserts. The arrangement and number of the connecting structures and of the associated inserts can be chosen in accordance with the shape and size of the object to be manufactured. On completion of manufacture, the individual inserts can be adjusted either simultaneously or successively (individually or in groups).

It is also possible, in the case of a plurality of through openings, for some of said openings to remain unused inasmuch as no adjustable inserts are arranged there but only stationary plugs, covers or the like, for example. In this case, no connecting structure is produced in the region of such a through opening, i.e. the metallic powder remains in its original condition there. As an alternative, it is also possible to arrange in some of the through openings inserts on which no connecting structures are produced and which are also not adjusted relative to the base plate on completion of the manufacturing process. The reason for such a variant is that there is, as it were, an overall number of through openings (with associated inserts) in the base plate, and, depending on the shape and size of the respective object to be manufactured, only some of these through openings are used, while others can remain unused. In order to achieve the greatest possible flexibility, the through openings can, for example, be arranged in accordance with a grid (e.g. a rectangle grid) along the base surface.

In one form, the object is connected exclusively to the at least one insert. That is to say that no connections to the base plate are established during the manufacturing process. Thus, the base plate comes into contact only with powder which is not melted or sintered. An expensive cleaning process or some other process for reconditioning the base plate on completion of the manufacturing process is thus eliminated. This entails a clear time and cost advantage.

As regards the adjustment, there are a large number of different possibilities. For example, it would be conceivable for an insert simply to be rotated within a cylindrical location opening, wherein the separation of the respective connecting structure is accomplished by means of the rotation. In addition, (linear) displacements of the inserts are also possible. According to one form of the present disclosure, the adjustment is accomplished by moving at least one insert in the direction of a rear side of the base plate. That is to say that, here, the insert is displaced away from the base surface in the direction of a rear side of the base plate, which faces away from said base surface. There, the corresponding through opening has a rear access through which the insert can also optionally be removed or inserted.

A corresponding movement in the direction of the rear side does not have to be purely linear but can also include a rotation. In one form, at least one insert is adjusted by means of a screw-like movement. That is to say that, in this case, a translation and a rotation of the insert are combined in a spiral or screw-like movement. On the one hand, forces required to separate the connecting structures can often be more easily produced by means of a corresponding torque in the context of the rotary motion than can tension forces in the case of a pure linear displacement, for example. At the same time, the separating process can be assisted by the motion component directed away from the buildup surface.

At least one insert can be adjusted by a screwed joint or a bayonet joint. In other words, in the first case the corresponding insert has an external thread which interacts with a corresponding internal thread of the through opening. Here, the insert can have a widened portion, which is dimensioned in such a way that it cannot be inserted into the through opening. For example, the insert can be shaped like a screw, wherein the widened portion forms the screw head. A widened portion of this kind forms a stop, by means of which an end position of the insert within the through opening is defined. Of course, an abovementioned screw-like movement is made possible by a threaded joint. The through opening can have a recess to accommodate the widened portion.

In the case of a bayonet joint, either a groove, into which a radially outward-directed extension of the insert engages, is formed on the inside of the through opening or a groove, into which a radially inward-directed extension of the through opening engages, is formed on the insert. It is a simple matter in each case for the groove to have an axially extending part and a tangentially extending part adjoining said axially extending part. However, it is also possible, as is known from BNC plugs for example, for part of the groove to be of helical design. In each case, the interaction of the groove and the extension provide a stop by means of which an end position of the insert within the through opening is likewise defined.

It is advantageous if predetermined breaking points, at which the connecting structures break as planned when the at least one insert is adjusted, are produced on the connecting structures. Of course, predetermined breaking points of this kind are local extended regions which have a smaller cross section than adjoining regions. As regards the envisaged adjusting movement of the respective insert, the structure of the predetermined breaking point can be enhanced in such a way that it breaks particularly easily under the action of those forces which occur during adjustment. If, for example, twisting of the insert occurs during adjustment, the predetermined breaking point can be designed in such a way that, although it withstands tension and/or compression forces, it yields relatively easily when shear forces occur.

In order to facilitate the application of the first powder layers, the at least one insert is arranged in such a way for manufacture that each partial surface, formed by an insert, of the base surface is flush with a partial surface formed by the base plate. In other words, the partial surface formed by the insert extends in one plane with the partial surface formed by the base plate. Such positioning can be facilitated in the manner described above by the presence of a stop which defines an end position of the insert in the through opening.

The method according to the present disclosure is suitable for full automation or a large degree of automation. In this context, it is desired that the at least one insert be motor-adjusted. That is to say that a motor-operated adjusting device is coupled to the insert at least for the adjusting process and adjusts said insert. In the case of a screw-type insert, the adjusting device can be a motor-operated screwdriver, which is moved up to the insert by a robot arm, for example, and then adjusts the insert by means of a screwing motion. Since the position of the base plate and thus also that of the inserts is known, the corresponding control of the adjusting device is relatively simple. It is once again advantageous here that the inserts can be adjusted from the rear side of the base plate.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a side view of a first form of an apparatus for carrying out a method according to the present disclosure during buildup of an object;

FIG. 2 shows a side view of a base plate of the apparatus from FIG. 1 with inserts according to the present disclosure;

FIG. 3 shows a side view of a base plate with a finished object according to the present disclosure;

FIG. 4 shows a side view of a base plate and an object during separation of connecting structures according to the present disclosure;

FIG. 5 shows a side view of an object with connecting structures after separation according to the present disclosure;

FIG. 6 shows a perspective partial sectional representation of part of a base plate and of an insert from FIG. 1;

FIG. 7 shows a perspective partial sectional representation of part of a base plate and of an insert according to a second form according to the present disclosure;

FIG. 8 shows a side cross-sectional view of part of a base plate and of an insert according to a third form according to the present disclosure; and

FIG. 9 shows a perspective illustration of a base plate according to a fourth form according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

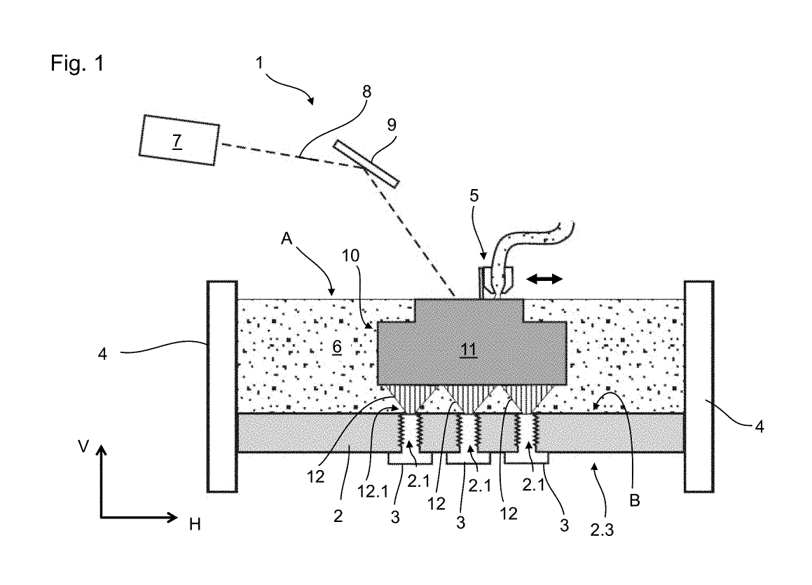

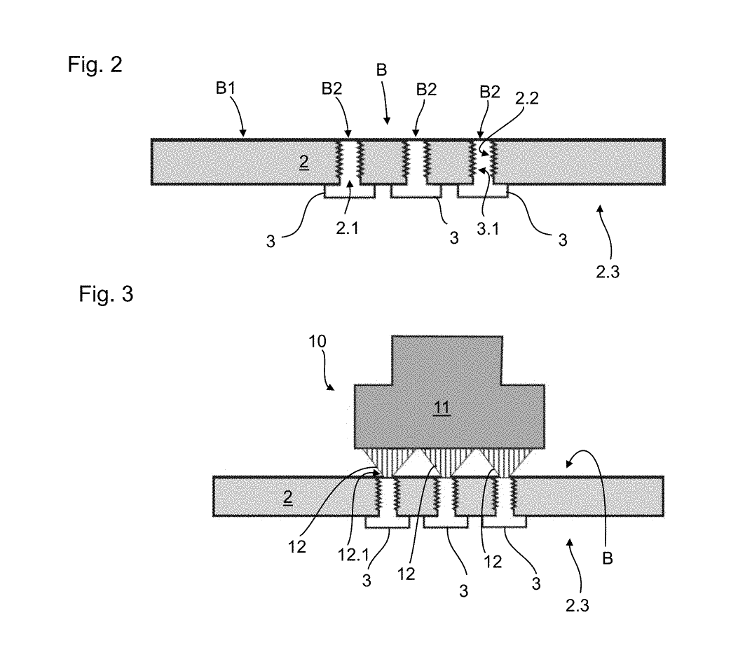

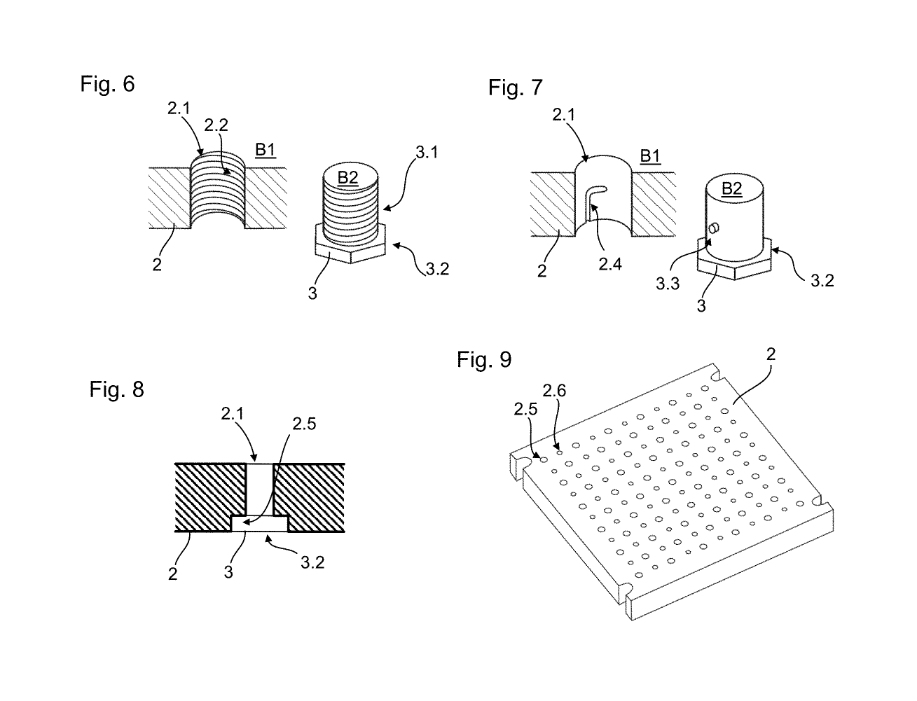

FIG. 1 shows a first form of a manufacturing system 1, by means of which the method according to the present disclosure can be carried out. The illustration is highly schematized and, for reasons of clarity, various parts of the manufacturing system 1 have been omitted. The figure illustrates a base plate 2 having a plurality of through openings 2.1, in each of which inserts 3 are arranged. As can be seen in the detail illustration in FIG. 6, each through opening 2.1 has an internal thread 2.2, which interacts with an external thread 3.1 of the respective insert 3. The respective insert 3.1 can be screwed into a through opening 2.1 or screwed out of said opening by exerting a torque on a head 3.2 having a hexagonal cross-section (wrench surface). In the example under consideration, the inserts 3 thus have the form of hexagon-head screws. Of course, it would also be possible to use a head 3.2 having a slot, a crosshead slot, an internal hexagon or the like, for example, instead of a hexagon head 3.2. As an alternative, as shown in FIG. 8, each through opening 2.1 could have a recess 2.5 to accommodate the head 3.2, allowing the head to be recessed. When screwed in, the inserts 3 form a base surface B together with the base plate 2, wherein a first partial surface B1 is formed by the base plate 2, and second partial surfaces B2 are formed by the inserts 3. Said surfaces B, B1, B2 can be seen from FIG. 2, where it can also be seen that the second partial surfaces B2 are flush with the first partial surface B1, i.e. lie in one plane.

Metal powder 6 is applied in layers to the base surface B by an application device 5, more specifically along a buildup surface A parallel to the base surface. The application device 5 can have a kind of nozzle or valve for dispensing powder and a smoothing device, e.g. a doctor. As indicated by the double arrow, the application device 5 can be moved parallel to the buildup surface A in order to distribute powder along the entire buildup surface A. The base plate 2 is adjoined on both sides by side walls 4, which inhibits metal powder 6 from trickling away sideways. In the example under consideration, the base surface B and the buildup surface A are parallel to the horizontal H, although deviations from this are also conceivable as long as the buildup plane A encloses an angle with the horizontal H which is smaller than the angle of repose of the metal powder 6. To protect the metal powder 6 from oxidation or to protect against explosions, the parts of the apparatus which are shown are normally accommodated in a housing (not shown here), which may be filled with inert gas.

When the application device 5 has applied a layer of metal powder 6, some of the powder 6 is selectively melted by means of a laser beam 8, thereby producing a layer of an object 10 to be manufactured. The laser beam 8 is produced by a laser 7 and is directed onto an envisaged coordinate within the buildup surface A by means of a pivotable mirror 9. Here, the activation of the laser 7 and the control of the mirror 9 are performed under computer control in accordance with predetermined CAM data of the object 10. While a powder layer is being applied and partially melted, the base plate 2 with the inserts 3 remains in a fixed position along the vertical V and is then lowered by a distance which corresponds to the envisaged layer thickness. For this purpose, the base plate 2 can be mounted on a lifting device (likewise not shown here).

By means of the action of the laser beam 8, the object 10 produced is strongly heated, even if the melted powder 6 solidifies again when the action of the laser beam 8 is ended. Since effective heat transfer is possible neither to the surrounding powder 6 nor to the inert gas, it is desired that heat transfer to the base plate 2 can take place in order to avoid thermally induced deformations of the object 10. To assist this process, connecting structures 12 connected to the inserts 3 are produced in addition to a component 11, which represents the usable part of the object 10 in this example. These connecting structures 12 can be used to stabilize the object 10, but they serve primarily for better heat dissipation to the inserts 3 and, from there, into the base plate 2. Heat conduction is promoted by the fact that both the base plate 2 and the inserts 3 are manufactured from metal, e.g. steel, and by the fact that they are in close thermal contact via the threads 2.2, 3.1.

In the example under consideration, the connecting structures 12 taper in the direction of the inserts 3, thereby in each case defining a predetermined breaking point 12.1 adjoining an insert 3, at which point the connecting structures 12 may break or crack. When viewed in section, the connecting structures 12 are, by way of example, shown as truncated cones, wherein the narrow bottom side thereof is arranged on the insert side and the wider top side thereof is arranged on the component side. The predetermined breaking point 12.1 is arranged on the insert side in the illustrative form shown.

FIG. 3 shows the base plate 2, the inserts 3 and the object 10 on conclusion of additive manufacture. The excess metal powder 6 has been removed and the base plate 2 has been removed from the manufacturing system 1. As is readily apparent here once again, the object 10 is connected to the inserts 3 exclusively via the connecting structures 12, i.e. there is no direct connection with the base plate 2. The base plate comes into contact only with unmelted powder and can therefore be reused without further processing.

In order to free the object 10 with the connecting structures 12, the inserts 3 are screwed out of the base plate 2 by operating the head 3.2. This involves a screw-like movement of the respective insert 3 within the through opening 2.1. Thus, a combination of shear and tension forces acts between the insert 3 and the connecting structure 12, leading to the connecting structure 12 breaking in the region of the predetermined breaking point 12.1, while the insert 3 is screwed out in the direction of a rear side 2.3 of the base plate, said side being situated opposite the base plane B. Unscrewing can be performed in a fully automatic manner, e.g. by means of a motor-operated screwdriver arranged on a robot arm. No separating tools are involved for this purpose, and separation can be carried out exclusively from the rear side 2.3 by adjusting the inserts 3 from there. Upon separation, slight residues of the connecting structure 12 normally remain on the respective insert 3, and therefore said insert cannot be reused without being reconditioned. For a further manufacturing operation, which can take place within a short time by virtue of the efficiency of separation, new inserts 3 can be screwed into the base plate 2.

FIG. 5 shows the object 10 after separation is complete, wherein the connecting structures 12 are still connected to the component 11. They can then be separated in a conventional manner, e.g. mechanically or by spark erosion.

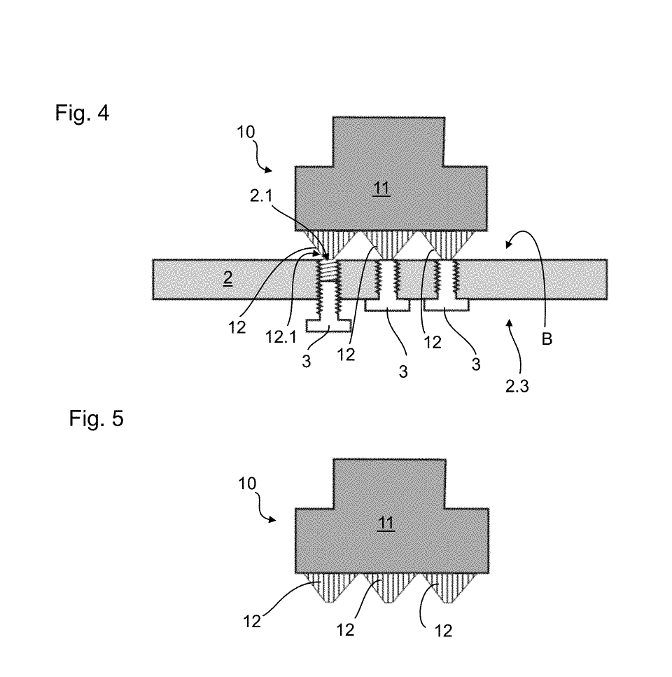

FIG. 7 shows a detail of an alternative form of an insert 3 and of a base plate 2, which are formed substantially as in FIGS. 1-6, although the insert 3 interacts with the through opening 2.1 via a bayonet joint. For this purpose, a groove 2.4, which interacts with a radially outward-directed extension 3.3 of the insert 3, is introduced into the through opening 2.1.

FIG. 8 shows a base plate 2 in which the through opening 2.1 has a recess 2.5, in which the head 3.2 of the insert 3 can be accommodated, said head in this case being of round rather than hexagonal design. The head 3.2 can have a slot, crosshead slot, internal hexagon, Torx® or the like, for example.

FIG. 9 shows an illustrative alternative form of a base plate 2, which has a multiplicity of through openings 2.5, 2.6, which are arranged in accordance with a rectangle grid. Here, larger through openings 2.5 in each case alternate with smaller through openings 2.6. It is self-evident that the through openings 2.5, 2.6 of different sizes are provided for inserts 3 of different diameters. The base plate 2 illustrated can be used to manufacture objects 10 of many different sizes and shapes, wherein in each case only the inserts 3 in some of the through openings 2.5, 2.6 are used. That is to say that connecting structures 12 are produced in association with only some of the inserts 3, while other inserts only come into contact with unmelted powder.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An additive manufacturing method comprising:
applying metallic powder layers to a base surface that is formed by a base plate and at least one insert arranged in a through opening in the base plate;
bonding at least one region of the metallic powder layers by heating, whereby an object having connecting structures that are connected to the at least one insert is manufactured; and
adjusting the at least one insert within the through opening relative to the base plate, thereby separating at least one part of the connecting structures from the at least one insert.

2. The manufacturing method as claimed in claim 1, wherein at least one insert is removed from the through opening after the separation of the connecting structures.

3. The manufacturing method as claimed in claim 1, wherein the base plate has a plurality of through openings, wherein an insert is arranged in each through opening.

4. The manufacturing method as claimed in claim 1, wherein the object is connected to the at least one insert via the connecting structures.

5. The manufacturing method as claimed in claim 1, wherein at least one insert is moved in a direction of a rear side of the base plate.

6. The manufacturing method as claimed in claim 1, wherein at least one insert is adjusted by a screw-like movement.

7. The manufacturing method as claimed in claim 1, wherein at least one insert is adjusted by a screwed joint or a bayonet joint.

8. The manufacturing method as claimed in claim 1, wherein predetermined breaking points are produced on the connecting structures and the connecting structures break when the at least one insert is adjusted.

9. The manufacturing method as claimed in claim 1, wherein the at least one insert is arranged in such a way for manufacture that each partial surface (B2), formed by an insert, of the base surface (B) is flush with a partial surface (B1) formed by the base plate.

10. The manufacturing method as claimed in claim 1, wherein the at least one insert is motor-adjusted.

11. The manufacturing method as claimed in claim 1, wherein a laser beam is used to bond the at least one region of the metallic powder layers.

12. An additive manufacturing method comprising:
distributing metal powder with an application device to a base surface that is formed by a base plate and at least one insert arranged in at least one through opening defined by the base plate;
moving the application device along a direction parallel to the base surface while distributing the metal powder to produce metallic powder layers;
selectively bonding at least one region of each metallic powder layer by heat to produce a layer of an object having connecting structures that are connected to the at least one insert; and
adjusting each insert within the through opening relative to the base plate to separate at least one part of the connecting structures from the at least one insert.

13. The manufacturing method as claimed in claim 12 further comprising lowering the base plate a distance that corresponds to a predetermined layer thickness after each layer of the object is produced until the object is manufactured.

14. The manufacturing method as claimed in claim 13 further comprising applying metallic powder to a buildup surface that is created when the base plate is lowered, wherein the buildup surface is parallel to the base surface.

15. The manufacturing method as claimed in claim 12, wherein a laser beam is used to bond the at least one region of each metallic powder layer.

16. The manufacturing method as claimed in claim 12, wherein the connecting structures are tapered such that each connecting structure defines a predetermined breaking point adjoining a corresponding insert.

17. The manufacturing method as claimed in claim 16, wherein the connecting structures break when the at least one insert is adjusted.

18. The manufacturing method as claimed in claim 12 wherein the at least one insert is adjusted by a screw joint or a bayonet joint.

19. The manufacturing method as claimed in claim 12, wherein the at least one insert is motor-adjusted.

20. The manufacturing method as claimed in claim 12, wherein the at least one insert is removed from the through opening after the at least one part of the connecting structures are separated from the at least one insert.
